(19) United States
(12) Patent Application Publication
(10) Pub. No.: US 2005/0108060 A1
(43) Pub. Date: May 19, 2005

(54) Medical image information management system

(75) Inventor: Yasuhiko Sasano, Tokyo (JP)

Correspondence Address: MUSERLIAN, LUCAS AND MERCANTI, LLP, 475 PARK AVENUE SOUTH, 15TH FLOOR, NEW YORK, NY, 10016, US

(73) Assignee: Konica Minolta Medical & Graphic, Inc.

(21) Appl. No.: 10/982,723

(22) Filed: Nov. 5, 2004

(30) Foreign Application Priority Data
Nov. 17, 2003 (JP) 2003-386419

(51) Int. Cl. G06F 17/60

(52) U.S. Cl. 705/3

(57) ABSTRACT

A medical image information management system includes: a database for storing medical image information including image data generated from a subject and accompanying information which is added to the image data; an area dividing section for dividing the database into a plurality of areas; a generation date and time obtaining section for obtaining generation date and time information from the accompanying information in the medical image information; and a distribution controlling section for distributing the medical image information to one of the plurality of areas in the database, according to the generation date and time information obtained by the generation date and time information obtaining section, wherein the system extracts desired image data in the database based on the accompanying information of the medical image information.

### BACKGROUND OF THE INVENTION

1. Field of the Invention

The present invention relates to a medical image information management system for managing image data of a medical image in which an image of a subject is generated and accompanying information which is added to the image data.

2. Description of Related Art

In a medical field, digitization of a medical image in which an image of a patient is generated is realized, and in association with the digitization, a medical image information management system is utilized. Such medical image information management system is used for integrally managing image data along with patient information of an image-generated patient, examination information or the like in a server, the image data corresponding to a medical image generated by various types of modalities such as a CR (Computed Radiography) apparatus, a CT (Computed Tomography) apparatus, an MRI (Magnetic Resonance Imaging) apparatus or the like and being digitized.

In the above-mentioned system, when a medical image generated by a modality is transmitted to a server, various information for identifying the medical image, such as patient information including a name of an image-generated patient, patient ID or the like, examination information including examination date, examination ID, a name of a doctor who has requested the examination or the like, series information including a modality name, an operator name, an examined region or the like, date of generating the medical image, bit information, etc, is accompanied with the medical image as accompanying information. Then, when the medical image is stored, the accompanying information added to the medical image is stored in database so as to relate it with the medical image.

At this time, by managing the image data of the medical image in a first storing means which stores the image data for a short period or a second storing means which stores the image data for a long period respectively, necessary image data is efficiently searched for and obtained according to necessity. A medical image information management system performing such operation is known (for example, see JP-Tokukai-2003-99465A, hereinafter, it is called a patent document 1).

However, in the case of the above-mentioned patent document 1, if this medical image information management system is used for a long period, the quantity of image data to be stored in the second storing means becomes enormous. Thereby, it is difficult to do the search because, for example, considerable amount of time is required to search for desired image data from the second storing means, etc.

### SUMMARY OF THE INVENTION

An object of the present invention is to provide a medical image information management system in which it is possible to efficiently search for medical image information.

In accordance with a first aspect of the present invention, a medical image information management system comprises: a database for storing medical image information comprising image data generated from a subject and accompanying information which is added to the image data; an area dividing section for dividing the database into a plurality of areas; a generation date and time obtaining section for obtaining generation date and time information from the accompanying information in the medical image information; and a distribution controlling section for distributing the medical image information to be stored in the database to one of the plurality of areas in the database, according to the generation date and time information obtained by the generation date and time information obtaining section, wherein the system extracts desired image data in the database based on the accompanying information of the medical image information.

According to the system of the first aspect of the present invention, the area dividing section in the medical image information management system divides a database which stores medical image information into a plurality of areas, the generation date and time information obtaining section obtains generation date and time information from accompanying information of the medical image, and the distribution controlling section distributes the medical image information stored in the database to one of the plurality of areas in the database to be stored according to the generation date and time information.

In other words, there are a plurality of areas for storing medical image information in the database, and it is possible to store medical image information so as to distribute the medical image information according to generation date and time information in the accompanying information.

Therefore, even if there are a large number of pieces of medical image information, the medical image information is separated and stored each of the plurality of areas according to a predetermined period and the like based on the generation date and time information. Accordingly, compared to a case of searching for and extracting desired medical image information from one area which stores all the medical image information, it is possible to perform more efficient search with medical image information obtained by searching in each of the divided areas.

Consequently, it is possible to say that this medical image information management system is a system capable of searching for a medical image efficiently.

In accordance with a second aspect of the present invention, a medical image information management system comprises: a database which comprises a first area for temporarily storing medical image information comprising image data generated from a subject and accompanying information which is added to the image data, and a second area for storing predetermined medical image information for a long period, the predetermined medical image information being among the medical image information stored in the first area; an area dividing section for dividing the second area of the database into a plurality of areas; a generation date and time information obtaining section for obtaining generation date and time information from the accompanying information in the medical image information; and a distribution controlling section for distributing the medical image information to be stored in the second area to one of the plurality of areas in the second area, according to the generation date and time information obtained by the generation date and time information obtaining section, wherein the system extracts desired image data in the database according to the accompanying information of the medical image information.

According to the system of the second aspect of the present invention, the area dividing section of the medical image information management system divides the second area of the database for storing medical image information into a plurality of areas, the generation date and time information obtaining section obtains generation date and time information from accompanying information of the medical image information, and the distribution controlling section distributes the medical image information stored in the database to one of the plurality of areas of the second area according to the generation date and time information.

In other words, there are a plurality of areas for storing medical image information in the second area of the database, and it is possible to store the medical image information to each of the plurality of areas so as to distribute the medical image information according to generation date and time information of the accompanying information.

In particular, since the database comprises the first area for temporarily storing medical image information and the second area for storing predetermined medical image information among the medical image information stored in the first area for a long period, it is possible to selectively store necessary medical image information in the second area.

Therefore, even if there are a large number of pieces of medical image information, the medical image information is separated and stored each of the plurality of areas according to a predetermined period and the like based on the generation date and time information. Accordingly, compared to a case of searching for and extracting desired medical image information from one area which stores all the medical image information, it is possible to perform more efficient search with medical image information obtained by searching in each of the divided areas.

Consequently, it is possible to say that this medical image information management system is a system capable of searching for a medical image efficiently.

Preferably, the system of the first aspect or the second aspect further comprises: a measuring section for measuring elapsed time since the medical image information is distributed to the one of the plurality of areas and stored; and an information moving section for moving the medical image information among the plurality of areas according to the elapsed time measured by the measuring section.

According to the above-mentioned system, it is possible that the measuring section measures elapsed time since the medical image information is distributed to a predetermined area and stored, and the information moving section moves the medical image information among the plurality of areas according to the elapsed time.

In other words, if the database comprises an update area for storing more recent medical image information, and an all previous area for storing medical image information whose retention period exceeds a predetermined retention period, when a date and time is updated and new medical image information is inputted, it is possible to move the oldest information in the update area to the all previous area.

Therefore, it is possible to perform the search so as to selectively extract more recent medical image information, whereby it is possible to search for medical image information efficiently.

### BRIEF DESCRIPTION OF THE DRAWINGS

The present invention will become more fully understood from the detailed description given hereinafter and the accompanying drawing given by way of illustration only, and thus are not intended as a definition of the limits of the present invention, and wherein:

FIG. 1 is a view showing a system structure of a medical image information management system 100 according to the present embodiment,

FIG. 2 is a view showing an internal structure of a server 20,

FIG. 3A is a view showing an example of a data structure of a patient information table 271, FIG. 3B is a view showing an example of a data structure of an examination information table 272, FIG. 3C is a view showing an example of a data structure of a series information table 273, FIG. 3D is a view showing an example of a data structure of an image information table 274, FIG. 3E is a view showing an example of a data structure of an image information storing management table 275, FIG. 3F is a view showing a correlation among the patient information table 271, the examination information table 272, the series information table 273, the image information table 274 and the image information storing management table 275, and

FIG. 4 is a flowchart illustrating an image information storing area generating process performed by the server 20.

### PREFERRED EMBODIMENTS OF THE INVENTION

Hereinafter, a medical image information management system according to an embodiment of the present invention will be described with reference to figures.

In the present embodiment, the following case will be described: When medical image information which is image data of a medical image to which accompanying information such as patient information, examination information, series information, image information and the like is added is inputted to a medical image information management system which stores the image information of the medical image in a predetermined image information table according to generation date and time information included in the accompanying information, by creating a new image information table at each time that a predetermined period has passed, image information is stored in a plurality of image information tables which have been divided into according to the predetermined period so as to separate the image information according to each period.

First, a structure of the present embodiment will be described.

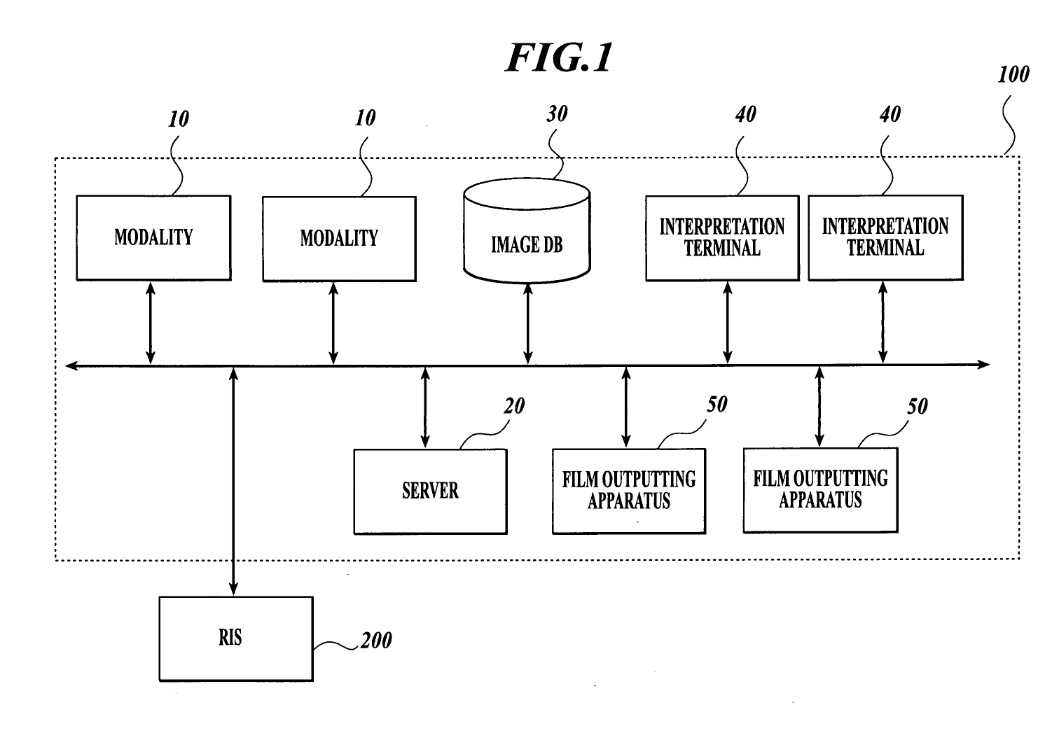

FIG. 1 shows a system structure of a medical image information management system 100 according to the present embodiment.

As shown in FIG. 1, the medical image information management system 100 comprises a modality 10, a server 20, an image DB (DataBase) 30, an interpretation terminal 40, and a film outputting apparatus 50, and each apparatus is connected through a communication network N which is configured according to DICOM (Digital Imaging and Communication in Medicine) standard so that mutual transmission/reception of data is possible. Here, in FIG. 1, although two modalities 10, two interpretation terminals 40, two film outputting apparatuses 50, one server 20 and one image DB 30 are connected, the number of each apparatus is not specifically limited.

Further, the medical image information management system 100 is connected to RIS (Radiology Information System) 200 through the communication network N.

The RIS 200 is an information management system for managing information in a radiology department, in which a request from a doctor is received, radiographing order information is generated, the radiographing order information including patient information regarding a patient to be radiographed (image-generated) such as patient ID, name, sex and the like, examination information regarding examination such as examination ID of the examination, radiographic region and radiographing method designated in the examination and the like, etc. Further, the RIS 200 manages the generated radiographing order information to which identification information thereof (hereafter, it is called order ID) is added. The RIS 200 transmits the generated radiographing order information to each modality 10 of the medical image information management system 100.

Here, in the present embodiment, what will be described is the example that an X-ray medical image is radiographed as a medical image, and the RIS is applied as an information management system. However, as an information management system, a reception terminal which receives a request to issue radiographing order information, HIS (Hospital Information System) which manages information in a hospital and the like can be also applied.

Hereinafter, each component of the medical image information management system 100 will be described.

The modality 10 is used for generating image data of an X-ray medical image in which an image of a patient is generated. As the modality 10, it is possible to apply a film digitizer which reads an X-ray image recorded in CR apparatus X-ray film, a reading apparatus which reads an X-ray image from a cassette in which the radiation image is recorded, and the like. Here, although a modality which radiographs an X-ray medical image is described as an example, when other types of medical images are generated, it is possible to apply other types of modalities such as an MRI apparatus, a CT apparatus, a sonography apparatus and the like.

The modality 10 radiographs (generates an image of) a patient according to radiographing order information generated by the RIS 200, and generates image data of the medical image. Then, the modality 10 adds patient information for identifying the medical image, examination information, series information and image information, to the image data as accompanying information of the generated medical image, and transmits the medical image with the accompanying information to the server 20. In particular, the image information includes generation date and time information which indicates date and time at which the image is generated.

The server 20 comprises database (DB) being a large-capacity storing section. The server 20 stores image data of a medical image transmitted from the modality 10 in the image DB 30, and builds a database according to patient information, examination information, series information and image information each of which is included in its accompanying information and stores the database in a fundamental information DB 27 as an information storing section in the server 20.

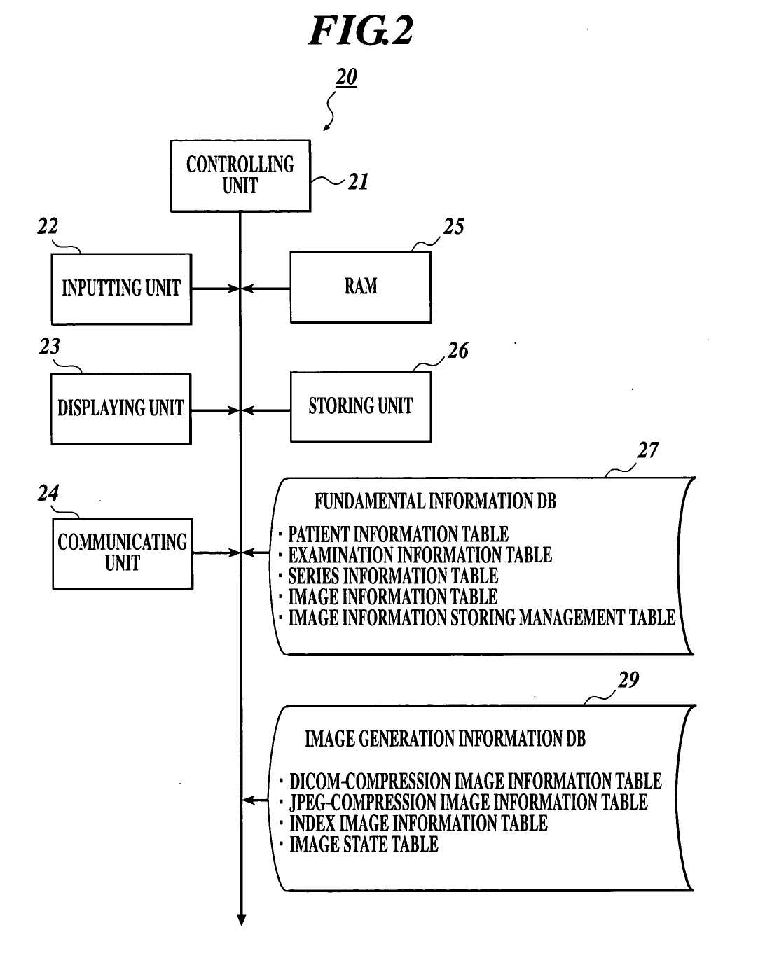

FIG. 2 shows an internal structure of the server 20.

As shown in FIG. 2, the server 20 comprises a controlling unit 21, an inputting unit 22, a displaying unit 23, a communicating unit 24, a RAM (Random Access Memory) 25, a storing unit 26, the fundamental information DB 27 and an image generation information DB 29.

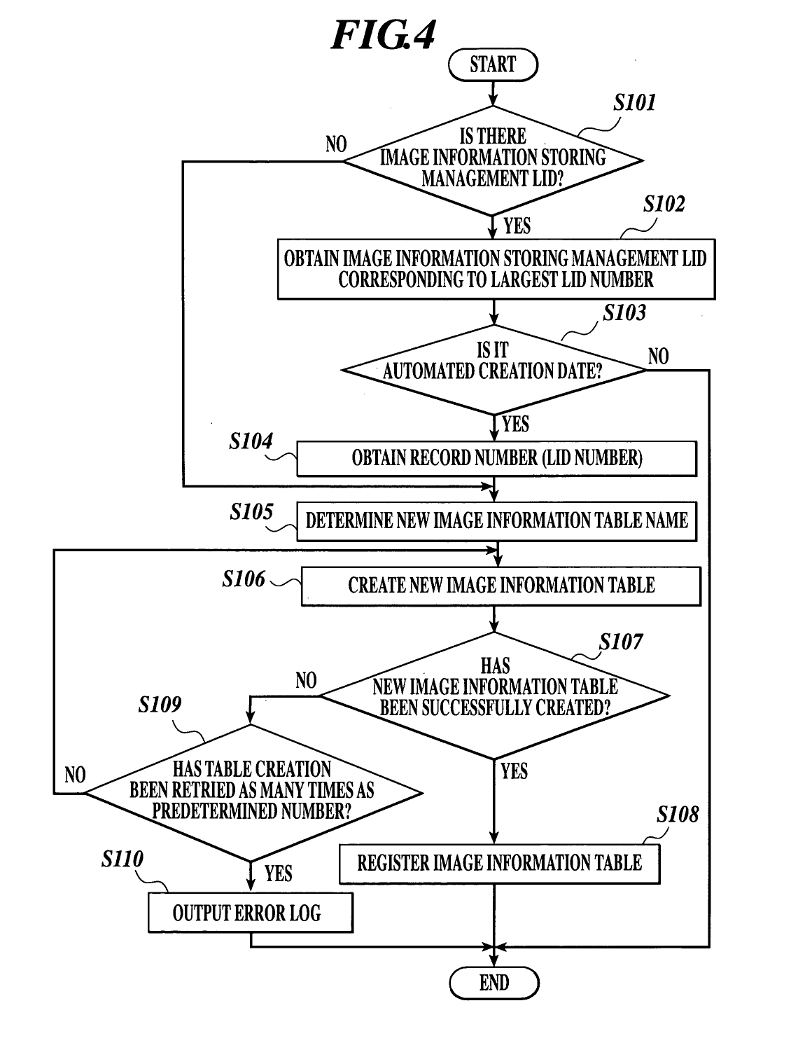

The controlling unit 21 comprises a CPU (Central Processing Unit) or the like. The controlling unit 21 develops a system program stored in the storing unit 26, a medical image storing process program, an image information storage area creating process program according to the present invention (see FIG. 4) and the like into the RAM 25, and integrally controls processing operations in conjunction with the programs.

In the medical image storing process, in the server 20, when receiving data of medical image information from the modality 10, the controlling unit 21 stores the medical image in the image DB 30 as an original image. Then, based on the original image stored in the image DB 30, a DICOM-compression image (an image compressed according to DICOM standard), a JPEG image (an image compressed according to JPEG principle), a thumbnail image for index use and the like are generated, and the image data is stored in the image DB 30.

Further, in the medical image storing process, in the server 20, when data of the medical image information is received from the modality 10, the controlling unit 21 executes a controlling process for obtaining generation date and time information regarding generation date and time of the medical image information from accompanying information (especially, image information) of the medical image information, as the generation date and time obtaining section.

Further, the accompanying information of the medical image obtained from the RIS 200 is stored in the fundamental information DB 27. In particular, an image storing process for distributing the image information of a medical image to a plurality of image information tables 274 in the fundamental information DB 27 to be stored based on the generation date and time information of the image information included in the accompanying information, as the distribution controlling section.

In the image information storage area creating process, a process which creates an image information table 274 as a new image information storage area so as to divide the fundamental information DB 27 at each predetermined period, which is previously set by the image information storage area creating process program, is performed as the area dividing section.

Further, after the image storing process is performed by the distribution controlling section, the controlling unit 21 performs a time measuring process for measuring elapsed time since the image storing process is performed, as the time measuring section.

Further, according to the elapsed time measured by the time measuring section, the controlling unit 21 performs a process which moves image information among the plurality of areas (among image information tables 274), as the information moving section.

In other words, based on the controlling section 21 acknowledging that the date and time is changed according to the measuring process by the time measuring section, when new medical image information is inputted, by the information moving process of the information moving section, the oldest information in an update area which stores more recent image information is moved to an all previous area which stores medical image information whose retention period exceeds a predetermined period so as to always store the latest information in the update area.

In other words, with the combination of the medical image storing process program and the controlling unit 21, it is possible to realize the generation date and time information obtaining section and the distribution controlling section. Further, with the combination of the image information storage area creating process program and the controlling unit 21, it is possible to realize the area dividing section.

Then, according to generation date and time information of the image information being accompanying information of a medical image, the image information of the medical image is stored in the plurality of image information tables which have been divided into according to each predetermined period. Thereby, it is possible to store image information so as to separate the image information according to each predetermined period.

The inputting unit 22 comprises a keyboard having numeric keys, letter keys, function keys and the like, a mouse, etc. The inputting unit 22 outputs an operation signal corresponding to an operated key to the controlling unit 21.

In particular, the inputting unit 22 functions as the inputting section, to which period setting information for setting a predetermined period is inputted, the predetermined period being a standard based on which a new image information table is created.

The displaying unit 23 is the displaying section comprising an LCD (Liquid Crystal Display) or the like, and displays a display screen on which accompanying information of a medical image (patient information, examination information, series information, image information and the like) stored in the fundamental information DB 27 is stored, and various types of operation screens.

The communicating unit 24 comprises a communications interface such as a network interface card, a modem or the like, and mutually transmits/receives information to/from an external device on the communication network N. The communicating unit 24 receives a medical image and its accompanying information from the modality 10. Further, the communicating unit 24 transmits a medical image to be stored to the image DB 30.

The RAM 25 forms a work area for temporarily storing various programs executed by the controlling unit 21 and data relating to these programs.

The storing unit 26 stores a system program, a medical image storing process program, an image information storage area creating process program, data processed by each program, etc.

In particular, the storing unit 26 functions as the storing section, which stores period setting information inputted through the inputting unit 22 in order to set a predetermined period which is a standard for creating a new image information table in the image information storage area creating process program. Further, the storing unit 26 also functions as the first area for temporarily storing inputted image information.

The fundamental information DB 27 comprises a large-capacity memory, in which a patient information table 271, an examination information table 272, a series information table 273, an image information table 274 and image information storing management table 275 are provided for storing accompanying information such as patient information, examination information, series information, image information and the like respectively, so as to relate each other. Here, the fundamental information DB 27 is the second area for storing predetermined image information among the image information stored in the first area, for a long period. The fundamental information DB 27 stores the predetermined image information for the long period in the image information table 274 which is created as a new image information storage area by dividing the fundamental information DB 27 into a plurality of areas.

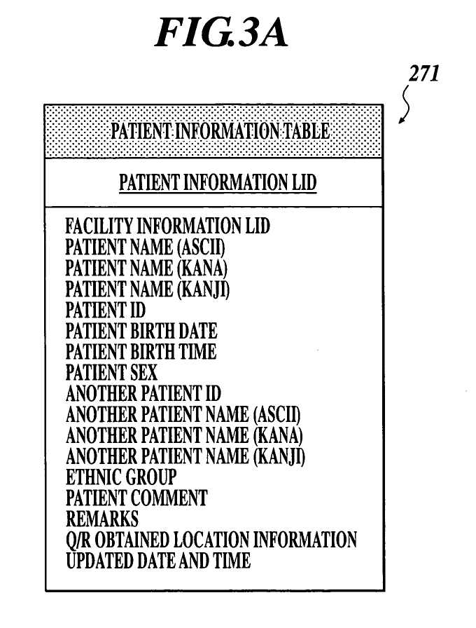

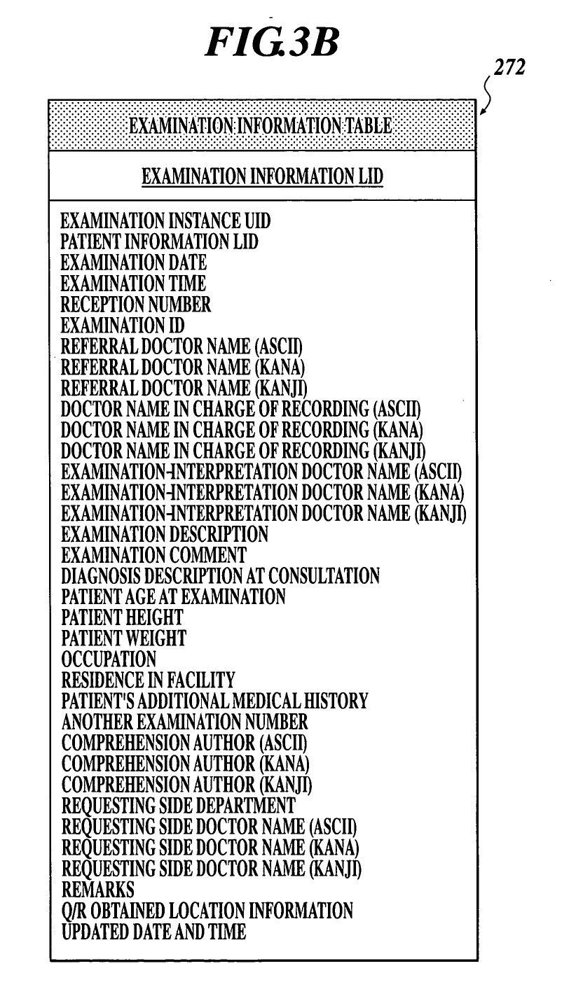

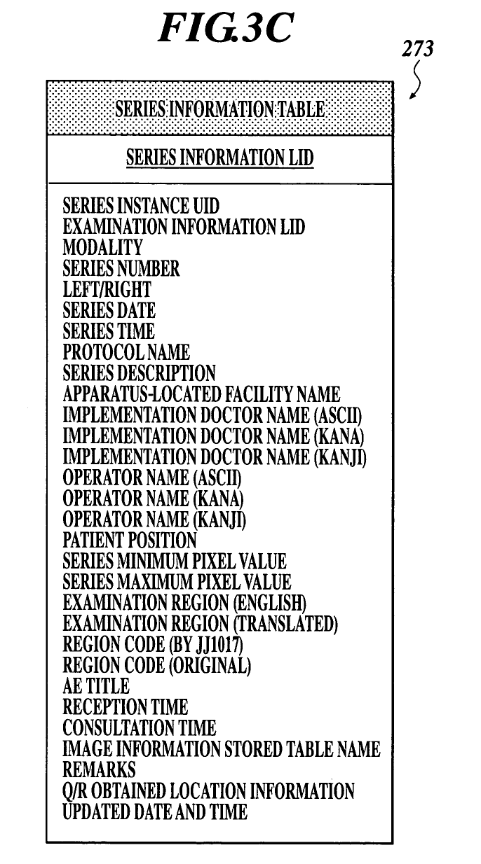

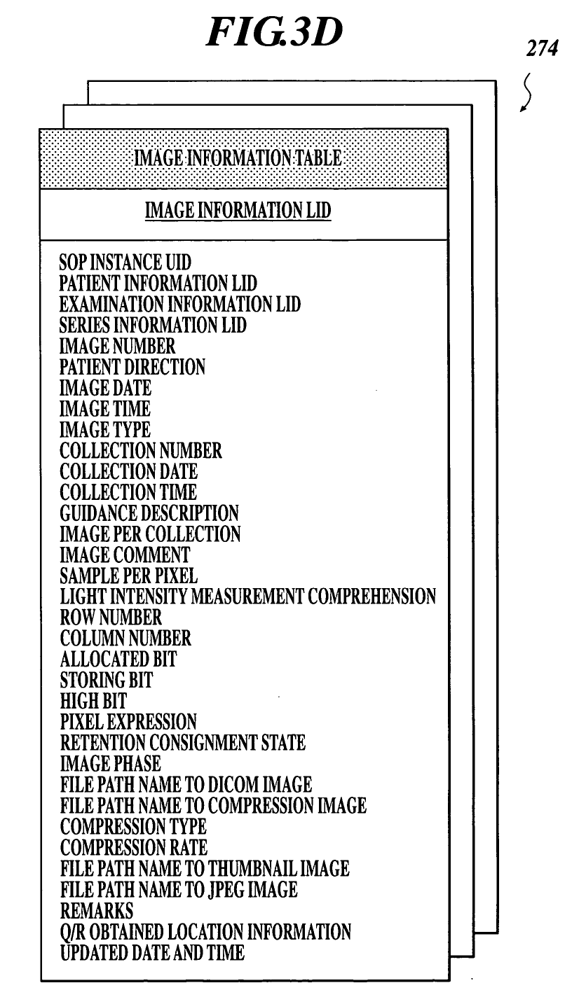

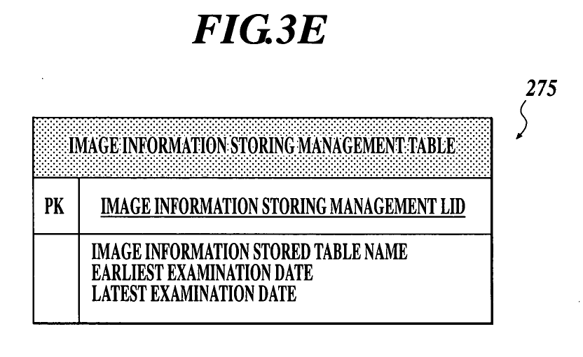

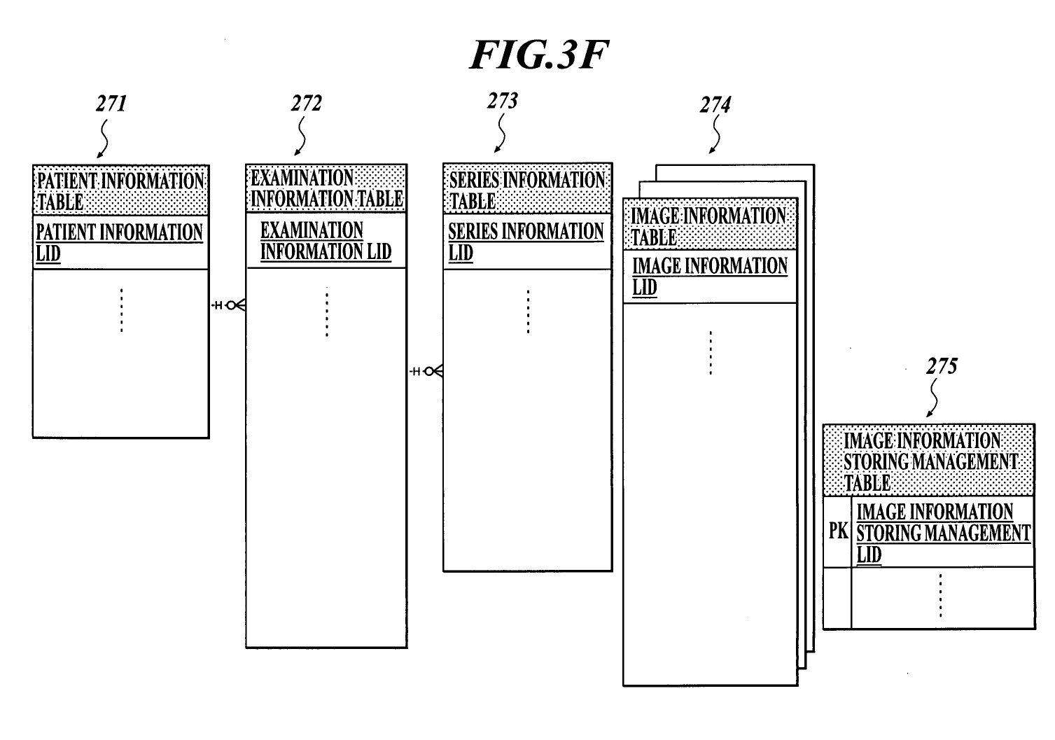

As shown in FIG. 3A, in the patient information table 271, stored is various item information regarding a patient such as a patient name (ASCII, kana, kanji), a patient ID, a birth date of the patient, sex and the like so as to relate them with identification information which is allocated for uniquely identifying the patient information and for relating the patient information with other accompanying information (this is called a patient information LID).

As shown in FIG. 3B, in the examination information table 272, stored are an examination instance UID which is issued for image management, an patient information LID corresponding to the examination information, and various item information regarding examination such as examination date, an examination ID, an examination interpretation doctor name and the like, so as to relate them with identification information allocated for uniquely identifying the examination information and for relating the examination information with other accompanying information (this is called an examination information LID).

As shown in FIG. 3C, in the series information table 273, stored are a series instance UID issued for image management, an examination information LID corresponding to the series information, and various item information regarding a modality and radiography (image generation) such as a name indicating a modality type, series number of the modality, a name of an operator who operates the modality, minimum pixel value that the modality is capable of reading, maximum pixel value that the modality is capable of reading, an examination region that the modality is capable of reading and the like, so as to relate them with identification information allocated for uniquely identifying the series information and for relating the series information with other accompanying information (this is called a series information LID).

As shown in FIG. 3D, in the image information table 274, stored are an examination instance UID issued for image management, an SOP instance UID structured by combining the series instance UID and an address indicating a file retention location of a medical image, a patient information LID corresponding to the image information, the examination information LID, the series information LID, and various item information regarding image management and image generation such as image number which is labeled when the image is generated, generation date and time information including date and time of the image generation, bit information including allocated bit and the like, file path names to each image such as an original image, a DICOM-compression image, a JPEG-compression image and a thumbnail image, compression rate, and the like, so as to relate them with identification information for uniquely identifying the image information and for relating the image information with other accompanying information (this is called an image information LID).

As shown in FIG. 3E, in the image information storing management table 275, stored are an image information stored table name, earliest examination date of image information stored in the image information table, latest examination date of the same, and the like.

The image generation information DB 29 comprises a DICOM-compression image management information table, a JPEG-compression image management information table, and an index image management information table, for respectively storing information regarding generation of a DICOM-compression image, a JPEG-compression image and a thumbnail image for index use each of which is generated based on an original image, such as generation date and time, compression rate and the like. Further, the image generation information DB 29 comprises an image state table for managing generation states of various images including a DICOM-compression image, a JPEG-compression image and a thumbnail image for index use. In the image state table, stored is flag data provided for each image, the flag data indicating whether the image has been generated or not.

The image DB 30 is an NAS (Network Attached Storage) for storing image data of a medical image generated by the modality 10. In the image DB 30, an original image generated by the modality 10, a DICOM-compression image, a JPEG-compression image and a thumbnail image generated by the server 20 based on the original image are stored in respective folders.

The interpretation terminal 40 is a displaying device for an interpretation doctor to interpret a medical image. The interpretation terminal 40 comprises the displaying section such as an LCD (Liquid Crystal Display) or the like, and displays image data of a medical image delivered from the server 20.

The film outputting apparatus 50 outputs image data of a medical image delivered from the server 20 on a film.

Next, an operation of the present embodiment will be described.

First, a medical image storing process which is performed by the server 20 when a medical image is stored will be described. Here, in the description, it is assumed that the RIS 200 transmits radiographing order information to the modality 10 by which the radiography is to be performed and the modality 10 radiographs a target patient according to the radiographing order information.

At first, when the modality 10 performs radiography (image generation) and image data of a medical image is generated, patient information of the radiographed (image-generated) patient, examination information, series information and image information (generation date and time information) are added to the image data as accompanying information of the medical image. Then, the medical image with the added accompanying information is transmitted to the server 20 through the network N.

When the server 20 receives data of the medical image and its accompanying information from the modality 10, in a DICOM communication task, the data of the medical image is stored in an original image folder within the image DB 30 as an original image. Then, as well as the accompanying information is stored in the fundamental information DB 27, image information of the medical image is stored in a predetermined table among the plurality of image information tables 274 according to generation date and time information of the image information included in the accompanying information.

When the accompanying information such as the image information and the like is stored in the fundamental information DB 27, various images which are necessary for interpretation are generated. First, when control information which requests image generation is generated in a queue reception monitoring task, in an image status management task, image generation is requested to DICOM-compression image management task, a JPEG-compression image management task and an index image management task. In each image management task, based on the original image stored in the image DB 30, a DICOM-compression image, a JPEG-compression image and an index image are generated and stored in each corresponding image folder within the image DB 30.

Next, when information regarding the generated image such as a file retention location of the images generated in each image management task is stored in the image generation information DB 29 and the image generation is completed, in an image status management task, a flag indicating the completion of the image generation is stored in the image state table of the image generation information DB 29, and the present process is completed.

Next, an image information storage area creating process which is performed by the server 20 and creates a new image information table 274 in the fundamental information DB 27 for each predetermined period will be described.

When the controlling unit 21 judges that a predetermined period has passed based on period setting information which is inputted through the inputting unit 22 and is stored in the storing unit 26, a new image information table is created based on the image information storage area creating process program.

Considering the case that a predetermined period during which image information is stored in the same image information table is set according to a day unit, for example, if an automated creation date and time is set so as to create a new image information table every ten days, the new image information table is created on the eleventh day from the earliest examination date so as to have a ten day period between the earliest examination date and the latest examination date of the image information stored in the latest image information table, and the image information having a new earliest examination date is stored in the created image information table.

Alternatively, considering the case that a predetermined period during which image information is stored in the same image information table is set according to a week unit, for example, if an automated creation date and time is set so as to create a new image information table weekly on every Sunday, a new image information table is created weekly on every Sunday and the image information having a new earliest examination date is stored in the created image information table.

Here, the setting of a predetermined period according to a week(s) unit is not limited to the weekly setting, but may be made according to two weeks unit or three weeks unit on a desired day of the week.

Alternatively, considering the case that a predetermined period during which image information is stored in the same image information table is set according to a month unit, for example, if an automated creation date and time is set so as to create a new image information table on the 1^{st} of every month, an automated creation date and time is set so as to create a new image information table on the 1^{st} of every month, and the image information having a new earliest examination date is stored in the created image information table.

Here, the setting of a predetermined period according to a month(s) unit is not limited to the monthly setting, but may be made according to two months or three months unit on a desired day of a month (for example, the 20^{th}).

Next, with reference to FIG. 4, a flow of the image information storage area creating process, which creates a new image information table 274 in the fundamental information DB 27, will be described. Here, in the description, it is assumed that the storing unit 26 of the server 20 stores therein an automated creation date and time for creating a new image information table and a retention period during which the image information is stored in the table as period setting information, and retry number which is the number of times to retry the creating process when a process for creating a new image information table is failed is set to the storing unit 26.

In the image information storage area creating process shown in FIG. 4, first, the controlling unit 21 confirms to see whether there is image information corresponding to LID number (existence of an image information storing management LID), which is also the record number of information recorded in the image information storing management table 275 (Step S101).

If the controlling unit 21 judges that there is image information corresponding to LID number (an image information storing management LID) (Step S101; Yes), the operation proceeds to Step S102. Then, the controlling unit 21 obtains a table name which stores the image information, earliest examination date and latest examination date, each of which corresponds to an image information storing management LID having the largest LID number (Step S102).

On the other hand, if the controlling unit 21 judges that there is no image information corresponding to LID number (an image information storing management LID), that is, LID number=0 (Step S101; No), the operation proceeds to Step S105.

Next, the controlling unit 21 compares the obtained earliest examination date and the latest examination date with a day and time of that moment (for example, whether a predetermined period has passed since the obtained earliest examination date, or whether the current day and time is after the obtained latest examination date), and judges whether it is a date to create a new image information table (automated creation date and time) (Step S103).

If the controlling unit 21 judges that it is a date to create a new image information table (automated creation date and time) (Step S103; Yes), the operation proceeds to Step S104. Then, the controlling unit 21 obtains record number (LID number) which indicates the number of records in the image information storing management table 275 (Step S104).

On the other hand, the controlling unit 21 judges that it is not a date for creating a new image information table (automated creation date and time) (Step S103; No), the image information storage area creating process is finished.

Next, by using a value equal to the obtained record number (LID number) plus one, an image information table name which is newly created is determined (Step S105). For example, the image information table name determined in this way can be IMAGE TBL1, IMAGE TBL2, IMAGE TBL3, . . . , so as to increase LID number as many as one at each time.

Then, by using the determined image information table name, a new image information table 274 is created in the fundamental information DB 27 so as to issue a DDL of the image information table (Step S106).

Next, the controlling unit 21 judges whether creation of the new image information table 274 is succeeded or not (Step S107).

If the controlling unit 21 judges that the creation of the new image information table 274 is succeeded (Step S107; Yes), the operation proceeds to Step S108. Then, the new image information table (LID number) is recorded and registered in the image information storing management table 275 (Step S108), and the image information storage area creating process is completed.

Here, in the image information storing management table 275, what is registered to the image information stored table name, the earliest examination date and the latest examination date regarding the image information table (LID number) being a new record, is the following information.

To the image information stored table name, registered is a table name determined in Step S105.

To the earliest examination date, registered is the next date of the latest examination date in an image information table obtained in Step S102. Further, if it is judged that there is no image information corresponding to LID number (LID number=0), the current day is registered.

To the latest examination date, registered is a date on which the predetermined retention period (for example, days) is passed since the newly registered earliest examination date.

On the other hand, the controlling unit 21 judges that the creation of a new image information table 274 is failed (Step S107; No), creation of the new image information table is retried as many times as predetermined retry number.

The operation returns to Step S106 and creation of the new image information table is retried until the controlling unit 21 judges that creation the image information table has been retried as many time as the predetermined retry number (Step S109; No).

If the controlling unit 21 judges that creation of the image information table has been retried as many times as the predetermined retry number (Step S109; Yes), an error log is outputted (Step S110) and the image information storage area creating process is completed.

As described above, according to the present embodiment, the server 20 of the medical image information management system 100 automatically creates a new image information table 274 in the fundamental information DB 27 at an automated creation date and time which is previously inputted and set. Then, according to generation date and time information included in image information which is accompanying information added to a newly-inputted medical image, it is possible to store the image information in a predetermined image information storage area.

In other words, in the fundamental information DB 27 of the server 20, there are a plurality of image information tables which have been divided into according to each predetermined period, and it is possible to store image information in each image information table 274 so as to separate the image information according to its generation date and time information.

Accordingly, even if there are a large number of pieces of image information for identifying a medical image of a patient, since the image information is stored in a plurality of image information tables 274 which have been divided into according to each predetermined period so as to separate the image information, by searching in each divided image information table 274 and by obtaining desired image information, it is possible to obtain a medical image identified by the image information.

In other words, if certain image information were to be obtained from one table that stores all the image information, considerable amount of time would be necessary for searching for desired image information among the large number of pieces of image information, whereby it would be difficult to perform the search. On the other hand, in the present embodiment, by storing image information in a plurality of image information tables 274 which are automatically created according to each predetermined period so as to separate the image information, it is possible to search for image information efficiently.

Therefore, it is possible to say that the medical image information management system is a system which is capable of searching for a medical image and obtaining it efficiently.

Here, the described content in the present embodiment is a suitable example of the medical image information management system to which the present invention is applied, and the present invention is not limited to the content.

For example, when capacity of each area for storing image information becomes close to full, a predetermined retention period of information may be reduced, for example, from three months to two months, in order to increase the total storing amount.

Further, described above is the case that accompanying information including patient information, examination information, series information and image information is stored in a plurality of areas (tables) in one DB. However, each accompanying information may be stored in a dedicated DB corresponding to a separate area.

Further, described above is the case that image data and accompanying information are stored in separate DBs, with the image DB 30 and the fundamental information DB 27 illustrated as a database for storing medical image information. However, the present invention is not limited to such case. Image data and accompanying information may be stored in the same DB.

And so forth, the detailed structure and the detailed operation of the medical image information management system 100 may be suitably changed without departing the gist of the present invention.

The entire disclosure of a Japanese Patent Application No. Tokugan 2003-386419 filed on Nov. 17, 2003, including specifications, claims, drawings and summaries are incorporated herein by reference in their entirety.

1. A medical image information management system comprising:
a database for storing medical image information comprising image data generated from a subject and accompanying information which is added to the image data;
an area dividing section for dividing the database into a plurality of areas;
a generation date and time obtaining section for obtaining generation date and time information from the accompanying information in the medical image information; and
a distribution controlling section for distributing the medical image information to be stored in the database to one of the plurality of areas in the database, according to the generation date and time information obtained by the generation date and time information obtaining section,
wherein the system extracts desired image data in the database based on the accompanying information of the medical image information.

2. A medical image information management system comprising:
a database which comprises a first area for temporarily storing medical image information comprising image data generated from a subject and accompanying information which is added to the image data, and a second area for storing predetermined medical image information for a long period, the predetermined medical image information being among the medical image information stored in the first area;
an area dividing section for dividing the second area of the database into a plurality of areas;
a generation date and time information obtaining section for obtaining generation date and time information from the accompanying information in the medical image information; and
a distribution controlling section for distributing the medical image information to be stored in the second area to one of the plurality of areas in the second area, according to the generation date and time information obtained by the generation date and time information obtaining section,
wherein the system extracts desired image data in the database according to the accompanying information of the medical image information.

3. The system of claim 1, further comprising:
a measuring section for measuring elapsed time since the medical image information is distributed to the one of the plurality of areas and stored; and
an information moving section for moving the medical image information among the plurality of areas according to the elapsed time measured by the measuring section.

4. The system of claim 2, further comprising:
a measuring section for measuring elapsed time since the medical image information is distributed to the one of the plurality of areas and stored; and
an information moving section for moving the medical image information among the plurality of areas according to the elapsed time measured by the measuring section.
